(19) United States
(12) Patent Application Publication
(10) Pub. No.: US 2003/0029545 A1
(43) Pub. Date: Feb. 13, 2003

(54) Method for making a carbon/carbon part

(76) Inventors: Lucien Fantino, Merignac (FR); Michel Boquet, Martignas (FR)

Correspondence Address: YOUNG & THOMPSON, 745 SOUTH 23RD STREET 2ND FLOOR, ARLINGTON, VA, 22202

(21) Appl. No.: 10/221,359

(22) PCT Filed: Jan. 23, 2002
(86) PCT No.: PCT/FR02/00282

(30) Foreign Application Priority Data
Jan. 24, 2001 (FR) 01/00943

(51) Int. Cl. C04B 37/00

(52) U.S. Cl. 156/89.26

(57) ABSTRACT

The object of the invention is a process for production of a carbon/carbon piece which is made from pieces cut out from a cloth of 2.5D, 3.5D or 4.5D and assembled to obtain a pre-form which is then densified with resin, gas or a mixture thereof.

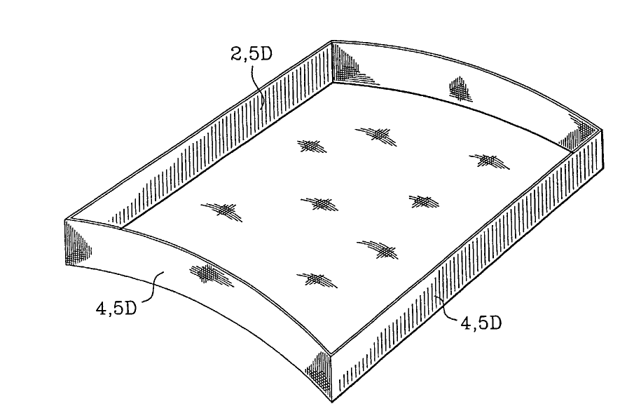

Application to the production of monolithic industrial pieces of carbon/carbon as furnace elements, beams or more complex structures.

The present invention has for its object a process for the production of a carbon/carbon piece.

Such a process permits producing industrial pieces, economically, particularly for furnace elements, confinement chambers, hearths, piece-carrying plates, high power resistances or containers for the chemical industry because carbon/carbon is very resistant to certain aggressive agents, even at high temperature.

Thus, it is known in the prior art to provide pieces of graphite of very high purity, nevertheless, in industrial applications, the lifetime is too short because of the fragility of this material.

This fragility is particularly troublesome when assembly and disassembly are frequent, when the pieces are handled or else because of cyclical thermal stresses.

Similarly, in certain cases, reagents placed in contact with the graphite at high temperature accelerate the weakening.

Another source of short lifetime comprises the modes of assembly themselves, of the elemental pieces which constitute the final product, because the connections do not withstand shocks and point overloads such as in the case of tapping.

Accordingly, graphite can preferably be replaced by a carbon/carbon material whose mechanical strength is greater.

It is known that when carbon is brought to temperatures higher than 2000° C. or even 2400° C., the graphitization of the carbon leads to a material having improved mechanical characteristics. The purification of the graphite is obtained by passing through a chlorinated atmosphere. U.S. Pat. Nos. 5,683,281 and 5,858,486 deal with this subject.

In the chemical field, there have also been surface coatings particularly by deposition of a carbon film to increase the chemical inertness of this material, but this solution is not satisfactory because it is delicate to use and of high cost.

To provide woven substrates, numerous techniques are used and there can be cited U.S. Pat. No. 5,858,486 which discloses a woven substrate in two dimensions and the associated process for positioning the fibers.

In U.S. Pat. No. 5,207,992, the composite is obtained by winding to a small thickness.

A known process for shaping a 2D cloth pre-impregnated with stamp/matrix assembly is disclosed in Japanese patent application JP 10-324591.

The object of the invention is to provide a process for the production of a carbon/carbon piece which is simple, which is to say whose number of steps to arrive at the finished product is reduced, whilst maintaining the necessary chemical purity and imparting sufficient mechanical characteristics, particularly for use in the production of industrial pieces as indicated in the preamble.

Shaping is a problem, because of the complex shapes of the products to be attained, the known techniques having recourse to known steps of winding and covering, require producing several elemental carbon/carbon pieces which must then be assembled.

The process according to the invention permits a very great adaptability or initial conformability so as to reduce the number of elemental pieces and even to obtain a substrate directly in the final shape of the piece.

Another problem to be solved is also to obtain a sufficient thickness to achieve the desired mechanical characteristics, which is solved by the process according to the invention.

In the case of carbon/carbon pieces, it is desirable to avoid any risk of delamination, and the present process prevents any starting of interlayer cleavage.

The process according to the present invention will now be described in detail.

An armature, so-called 2D, is an armature with fibrous reinforcement oriented in two directions, but its mechanical resistance is very low in the perpendicular direction. Cleavages can take place easily during production, which renders such an armature difficult to use in the envisaged applications. Once the material is produced, the matrix is insufficient to ensure sufficient cohesion in certain uses and it has risk of delamination.

In the case of a 3D armature, fragility in the perpendicular direction is overcome because the structure has fibers oriented along the three axes of a trihedral or according to a polar system.

Nevertheless, too great spacing between the layers of the filaments and the cavities of large dimensions thus arising, pose problems for controlling the thickness and impede densification. Moreover, armatures of this type are difficult to shape.

French patent 2 610 951, in the name of the applicant, discloses a process for the production of a particular woven armature, called 2.5D.

This 2.5D armature consists in interlacing the warp and weft threads so as to obtain a material having excellent resistance perpendicular to the plane of the armature without however there being filaments perpendicular to this armature.

It is thus possible to shape this armature, which permits, despite a very large content of fibers, good flow of the gaseous or liquid matrix according to the densification process used.

There are also known from French patents 2 753 993 and 2 718 757, armatures of the 3.5D and 4.5D type, which have the same advantages. The isotropy of these materials permits increasing the mechanical resistance and these materials are of interest in certain applications for which there is sought a high resistance and/or great stiffness.

As to the problem of fragility of the connections which the graphite can cause, it is solved in the present invention for pieces of carbon/carbon by recourse to known assembly processes.

Reference can be had to French patent 2 687 174, in the name of the same applicant, whose content is incorporated herein by reference. This patent discloses a process for assembly of pieces by stitching without knotting a continuous filament, the pieces being superposed or having an angulation relative to each other.

French patent 2 718 757, also in the name of the same applicant, completes this process for assembly of pieces by stitching, by introducing loops through several compressed thicknesses, the filaments being simply held by friction through the thicknesses. The teaching of this document must be considered as contained in the present description.

The process according to the present invention consists in producing industrial pieces directly with a dry or pre-impregnated cloth, at least of 2.5D. More particularly, the cloth is shaped in a single operation thanks to a shaping support. There can thus be produced flat pieces, hollow pieces, cylindrical pieces, conical pieces or skewed pieces. An example is given in the accompanying single figure.

Thus, the process consists in the sequence of the following steps:

a)—weaving an armature of 2.5D, 3.5D or 4.5D from carbon filaments,

b)—cutting off elemental pieces to constitute the different portions of the product,

c)—assembling by stitching these elemental pieces to produce a monolithic assembly,

d)—shaping these assembled elemental pieces, and

e)—densification,

steps c) and d) can be reversed according to the uses, without this changing the process, which gives the following sequence:

a)—weaving an armature of 2.5D, 3.5D or 4.5D from carbon filaments,

b)—cutting off elemental pieces to constitute the different portions of the product,

d)—shaping these pieces,

c)—assembly by stitching of these elemental pieces to produce a monolithic assembly, and

e)—densification.

Cutting off takes place with high precision so as to achieve substantially the final size.

Densification is an important step and it should be optimized.

The known ways are densification by gaseous means, by resin, or a mixture.

For each of these ways, there is the advantage to play several roles at each step so as to decrease the number, the time and the cost of production.

In the case of the gaseous way, the use of a cloth of 2.5D, 3.5D or 4.5D permits having good circulation of the gaseous flow although the quantity of fibers is high. This permits densifying the piece in depth and not only at the surface, by forming a sort of crust without the core being really reached.

In the case of the resinous way, according to the invention, there is carried out an impregnation of the textile pre-form and it is polymerized so as to set this pre-form as it is finally to be, all this being conducted in the course of a same operation which concludes by pyrolysis. Supplementally, the step of pyrolysis is prolonged beyond the temperature necessary for pyrolysis alone and as it should be conducted in a controlled neutral atmosphere, it is possible to stabilize and purify the material.

In the case of certain pieces, there should be repeated several times the step of impregnation up to, thermal treatment. This permits having a piece of sufficient rigidity to be handled.

By the resin way, there is obtained the succession of the following steps:

a)—weaving an armature of 2.5D; 3.5D or 4.5D from carbon filaments,

b)—cutting off from this armature elemental pieces to constitute the different portions of the product,

c)—assembling by stitching these elemental pieces to form a monolithic assembly of the size of the finished piece,

d)—emplacing the monolithic assembly on a support for shaping,

e1)—impregnation of this armature with a resin composition and drying, between a) and b) and/or b) and c) and/or between c) and d),

e2)—polymerization of this monolithic assembly and withdrawal of this assembly from the shaping support,

e3)—pyrolysis of this polymerized monolithic assembly,

e4)—repetition of the steps of impregnation and pyrolysis to obtain the desired density.

The mixed way is definitely the preferred way of procedure because it combines synergetically these steps. This way consists in preparing a textile pre-form as for the resin way, by pre-impregnation, then ensuring a first rapid densification and to the core, but with a suitable dosage of resin such as to generate a residual porosity which permits the ultimate circulation of a gas. Because of this, the densification is complemented by a gaseous way step. Conducting heating at high temperature under vacuum and without chlorinated gas permits purifying the piece.

There is obtained the sequence of the following steps:

a)—weaving an armature of 2.5D; 3.5D or 4.5D from carbon filaments,

b)—cutting off from this armature elemental pieces to constitute the different portions of the product,

c)—assembly by stitching of these elemental pieces to form a monolithic assembly of the size of the finished piece,

d)—emplacing the monolithic assembly on a support for shaping,

e1)—impregnation of this armature with a resin composition and drying, between a) and b) and/or between b) and c) and/or between c) and d),

e2)—polymerization of this monolithic assembly and withdrawal of this assembly from the shaping support,

e3)—first pyrolysis of this polymerized monolithic assembly,

e4)—if desired repetition of the steps of impregnation and pyrolysis, and

e5)—densification by gaseous way of the piece thus obtained to obtain the desired density.

In the three cases, possible machining of certain zones may be necessary for precise finishes but it remains very limited because the deformations must be limited.

It will be noted that the use of a cloth of at least 2.5D in the process according to the invention permits variations in the thickness of the armature so as to reinforce the mechanical resistance or to increase deformability, this by causing the relative quantities of warp and weft threads to vary.

Moreover, there can be chosen different types of fibers as a function of needs of thermal conductivity or electrical conductivity during the basic weaving.

An example is given hereafter relating to the use of the process according to the present invention for the production of a furnace element. This furnace element has a complex shape because it has a conical-cylindrical shape cut off into elemental portions which are assembled together.

The dry cloth is made of 2.5D, particularly with the following characteristics:

17 levels of woven carbon fiber,

4 mm thickness after polymerization,

30 filaments/cm in the warp direction,

16 filaments/cm in the weft direction,

quantity of fibers in the warp direction: 20%

quantity of fibers in the weft direction: 40%, and

weight per unit area 4 kg/M².

The dry cloth is then made of 4.5D to form reinforcements with the following characteristics:

57 levels of woven carbon fiber,

10 mm thickness after polymerization,

elemental pattern at 90°, 45°, 0° and 135° repeated 14 times with a last layer at 90°, and

weight per unit area at 9.8 kg/M².

At the outlet of the material to be woven, the widths are cut off at a given width of 1.5 m and at a necessary length of 1.5 m.

The widths thus cut off should be free from traces of water and passage through an oven at 80° C. for two hours permits assuring this.

The widths thus dried should be impregnated with a resin. This is carried out by batch-wise immersion, in this embodiment.

The immersion solution is, in a known manner, a phenolic resin of high purity diluted in an alcohol solvent, which facilitates impregnation.

The dosage with resin is of the order of 4 kg to 9 kg per square meter of cloth in the case of 2.5D or 4.5D. The widths are then drained on screens covered with a polyethylene film so as to avoid any stitching of the width to the screens.

The widths are then dried by passage through an oven at 45° C.

The widths, after having been thus impregnated, are cut off so as to obtain directly from a same width, a piece to cover the conical-spherical shape desired or the necessary reinforcement. A test sample is set aside to monitor the quantity of resin taken up by the cloth.

The reinforcing strips of 4.5D are disposed about the periphery of a stamp in their final position.

Holding elements are put in place in the form of plates.

The reinforcements are then interconnected by stitching at the four corners.

The piece of 2.5D is then placed on and pressed against the stamp, covering it edge to edge with strips of 4.5D, the 2.5D piece is then connected by stitching over all the periphery of the reinforcing strip so as to obtain a single monolithic piece.

The following step consists in proceeding with a backing to ensure draining under vacuum of the piece.

A bladder is connected to the piece and the peripheral sealing is carried out so as to provide pressing under isostatic vacuum.

The polymerization can begin to be carried out in an oven at at least 180° C.

After cooling, the backing is removed so as to remove the bladder and the different accessories and to free the furnace element thus treated whose polymerized resin provides a certain mechanical strength.

The furnace element is preferably protected during its subsequent movements to avoid any pollution.

The furnace element is then baked for 48 hours at a temperature comprised between 1700 and 2200° C. maximum, in a nitrogen flow under a vacuum of the order 10 mbars.

The structure thus obtained is entirely carbon and there is then carried out a vapor phase deposition of carbon (DCVP) so as to produce a carbon/carbon structure and to give to the furnace element the desired density, in the present case a density of about 1.7.

The densification furnace permits bringing the structure to a temperature comprised between 950° C. and 1100° C. under methane flow with a vacuum comprised between 7 and 15 mbars, for several hundreds of hours, in this case 400 hours to give an order of magnitude, the time being that necessary to obtain the desired density.

The carbon/carbon furnace element thus obtained is finally machined to give it the desired dimensions.

The furnace element thus produced can also be ultimately subjected or better immediately after densification, to a final step in the course of which the furnace element is subjected to a temperature comprised between 1700 and 2900° C. in a nitrogen stream under vacuum of 10 mbars for 48 hours.

There is thus obtained a furnace element with characteristics of purity that are entirely satisfactory for the needs of industry.

Another example consists in producing I-beams by assembling the flanges and the web cutting with stitching and without knotting or by friction.

Similarly, the production of complex pieces such as frames with arches are made possible.

Thus, the mechanical resistance of a piece is sufficient when it is produced in a single piece although the production of several pieces requires an assembly which is not simple or even impossible in certain cases such as angles of frames for example.

1. Process for the production of a carbon/carbon product, characterized in that it comprises the following steps:
a)—weaving an armature of 2.5D, 3.5D or 4.5 D from carbon filaments,
b)—cutting off elemental pieces to constitute the different portions of the product,
c)—assembling by stitching these elemental pieces to produce a monolithic assembly,
d)—shaping these assembled elemental pieces, and
e)—densification.

2. Process for the production of a carbon/carbon product, characterized in that it comprises the following steps:
a)—weaving an armature of 2.5D, 3.5D or 4.5D from carbon filaments,
b)—cutting the elemental pieces to constitute the different portions of the product,
d)—shaping these pieces,
c)—assembling by stitching these elemental pieces to produce a monolithic assembly, and
e)—densification.

3. Process for production according to claim 1 or 2, characterized in that the densification e) is carried out in a gaseous way under a controlled atmosphere.

4. Process for production according to claim 1 or 2, characterized in that the densification is carried out in a resin way and comprises the following steps:
a)—weaving an armature of 2.5D, 3.5D or 4.5D from carbon filaments,
b)—cutting out from this armature elemental pieces to constitute the different portions of the product,
c)—assembly by stitching of these elemental pieces to form a monolithic assembly of the size of the final piece,
d)—emplacing the monolithic assembly on a support to shape it,
e1)—impregnation of this armature with a composition of resin and drying, between a) and b) and/or between b) and c) and/or between c) and d),
e2)—polymerization of this monolithic assembly and withdrawal from this assembly of the shaping support,
e3)—baking this monolithic polymerized assembly,
e4)—repetition of the steps of impregnation and baking to obtain the desired density.

5. Process for production according to claim 1 or 2, characterized in that the densification is carried out by a mixed way and comprises the following steps:
a)—weaving an armature of 2.5D; 3.5D or 4.5D from carbon filaments,
b)—cutting out from this armature elemental pieces to constitute the different portions of the product,
c)—assembly by stitching of these elemental pieces to form a monolithic assembly with the size of the final piece,
d)—emplacement of the monolithic assembly on a support for shaping it,
e1)—impregnation of this armature with a resin composition and drying, between a) and b) and/or between b) and c) and/or between c) and d),
e2)—polymerization of this monolithic assembly and withdrawal of this assembly from the shaping support,
e3)—first baking of this polymerized monolithic assembly,
e4)—possible repetition of the steps of impregnation and baking, and
e5)—densification by the gaseous way of the piece thus obtained to obtain the desired density.

6. Process for production according to any one of the preceding claims, characterized in that the last step of heating to bake or densify is followed by a step of purification at very high temperature comprised between 1700° C. and 2900° C., under vacuum.

7. Process for production according to any one of the preceding claims, characterized in that the elemental cutout pieces are assembled by stitching without knotting of a continuous filament.

8. Process for production according to any one of claims 1 to 6, characterized in that cutout elemental pieces are assembled by stitching comprising the introduction of loops through the different thicknesses, the filaments being held by friction.

9. Process for production according to any one of the preceding claims, characterized in that the quantity of fibers and the nature of the fibers vary so as to adapt to different parameters such as strength, shapebility and conductivity.

10. Process for production according to any one of the preceding claims, characterized in that the monolithic assembly shaped on the support is subjected to a pressing operation by emplacement in a vessel provided to be placed under vacuum and ensuring isostatic pressing and immobilization of said assembly.

11. Process for production of a furnace element by the practice of any one of the preceding claims, characterized in that there is used a cloth of 2.5D which has the following parameters:
17 layers of woven carbon fibers AU4 GCP,
4 mm thickness after polymerization,
30 fibers/cm in the warp direction,
8 filaments/cm in the weft direction,
quantity of fibers in the warp direction: 20%
quantity of fibers in the weft direction: 40%, and
weight per unit area 4 kg/M².

12. Process for production of stiffeners of a furnace element by the practice of any one of the preceding claims, characterized in that there is used a cloth of 4.5D which has the following parameters:
57 levels of woven carbon fibers,
10 mm thickness after polymerization,
elemental pattern at 90°, 45°, 0° and 135° repeated 14 times with a final layer at 90°, and
weight per unit area of 9.8 kg/m².

13. Process for production of a furnace element according to claim 11 or 12, characterized in that it comprises the following steps:
cutting out widths from this cloth and drying to remove any trace of water,
impregnation of these widths with a phenolic composition diluted with alcohol in an amount of 4 to 9 kg per square meter of cloth in the case of 2.5D or 4.5D, and drying, this quantity of resin being suitable to generate a given porosity after baking,
cutting out from these widths, pieces to produce the furnace element and its stiffeners,
assembly by stitching without knotting these elemental pieces to form a monolithic assembly of the size of the finished piece,
placing the monolithic assembly in a bladder,
polymerization at 180° C. of this monolithic assembly and withdrawal of the bladder and the shaping support,
first baking of this monolithic polymerized assembly at a temperature comprised between 1700° C. and 2200° C. in a nitrogen stream with a vacuum of the order of 10 mbars, and
densification by the gaseous route at a temperature comprised between 950 and 1000° C. in a methane stream, of the piece thus obtained, to obtain the desired density.
